(19) United States
(12) Patent Application Publication
(10) Pub. No.: US 2007/0262956 A1
(43) Pub. Date: Nov. 15, 2007

(54) Input method with a large keyboard table displaying on a small screen

(75) Inventor: Steven Chen, Changhua (TW)

Correspondence Address: BRUCE H. TROXELL, SUITE 1404, 5205 LEESBURG PIKE, FALLS CHURCH, VA, 22041, US

(73) Assignee: E-LEAD ELECTRONIC CO., LTD.

(21) Appl. No.: 11/431,057

(22) Filed: May 10, 2006

(51) Int. Cl. G09G 5/08

(52) U.S. Cl. 345/157

(57) ABSTRACT

An input method with a large keyboard table displaying on a small screen employs a cursor controller to display the larger keyboard table on a small screen includes at least the following steps of: determining the position of a cursor on a keyboard table through the position of a finger on the cursor controller; determining the display area of the keyboard table through the position of the cursor on the keyboard table and displaying on a screen; determining movement of the cursor or moving the keyboard table inverse according to the position and moving direction of the cursor, and altering the display area; marking overlapping characters of the keyboard table and the cursor; and depressing to confirm input of the marked characters. Through this method convenience of input operation improves and data entry can be done faster.

### BACKGROUND OF THE INVENTION

1. Field of the Invention

The invention relates to an input method with a large keyboard table displaying on a small screen to improve operation convenience and facilitate fast data entry.

2. Description of the Prior Art

Portable electronic devices (such as PDAs, mobile phones, navigation display and the like) always demand thin and light. Hence the screen generally is made at a smaller size. The input device usually adopts an extra shrunk QWERTY keyboard, handwritten input or a keyboard table on the screen. Input through the keyboard table on the screen generally has two types: one uses a stylus to directly input on a touch-sensitive screen, another controls movement of the cursor on the keyboard on the screen through a cursor controller to select characters required.

### SUMMARY OF THE INVENTION

The input method mentioned above have their advantages. However, as a portable electronic device 1 has a rather small screen 11 (referring to FIG. 1), to display a complete keyboard table 110 on the screen 11 the size of the keyboard table 110 has to be shrunk to match the screen 11. It is not easy to use, especially for people of older age or poorer eyesight.

Therefore the object of the invention is to provide an input method with a large keyboard table displaying on a small screen to improve operation convenience and facilitate fast data entry. The method includes at least the following steps:

determining the position of a cursor on a keyboard table through the position of a finger on a cursor controller;

determining a display area of the keyboard table through the position of the cursor on the keyboard table and displaying on a screen;

determining movement of the cursor or moving the keyboard table inverse according to the position and moving direction of the cursor and altering the display area;

marking overlapping characters of the keyboard table and the cursor; and

depressing to confirm input of the marked characters.

By means of the foregoing procedures operation on the large keyboard table displaying on the small screen improves, and data entry speed can be increased.

To implement the input method of the invention, the cursor controller is a two-stage touch-sensitive pad. The first step aims to control movement of the cursor on the screen through the depressing position of a user's finger. The second step is depressing of the user's finger to confirm input of the character or function where the cursor is located.

In one aspect, the touch-sensitive pad of the cursor controller controls the cursor on the screen through an absolute coordinate.

In another aspect, the screen is a display panel smaller than 8 inches.

In yet another aspect, the height and width of the screen is smaller than the height and width of the complete keyboard table to be displayed.

In still another aspect, the cursor on the screen is controlled by the cursor controller and has a cursor mark on the screen.

In yet another aspect, the cursor on the screen is a character or function key selected and marked on the keyboard table by the cursor controller.

In yet another aspect, the keyboard table is a table or graphic consisting of a plurality of characters or function keys.

In yet another aspect, the keyboard table is a complete keyboard table larger than the size of the display area of the screen (in terms of height or width), and the screen can display only a portion of the keyboard table.

In yet another aspect, the keyboard table automatically appears on the display area of the screen when the cursor controller is operated by a user. The keyboard table automatically disappears from the display area of the screen when the cursor controller is not operated by the user for a selected time period.

In yet another aspect, the step of determining movement of the cursor or moving the keyboard table inverse according to the position and moving direction of the cursor means that when the cursor on the screen is moved close to one side of the keyboard table, the keyboard table moves on the screen in an opposite direction until the display area of the keyboard table displays the cursor and one border of the keyboard table at the same time, then the movement of the keyboard table stops, and the movement is replaced by the cursor.

In yet another aspect, the step of determining movement of the cursor or moving the keyboard table inverse according to the position and moving direction of the cursor means that the cursor remains still on a selected position on the display area, and the keyboard table moves on the screen in an opposite direction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional electronic device with a displaying keyboard table.

FIG. 2 is a schematic view of an embodiment of the invention.

FIG. 3 is a sectional view of the cursor controller of the invention.

FIG. 4 is a flow chart of the method of the invention.

FIG. 5 is another flow chart of the method of the invention.

FIG. 6 is a schematic view of the invention in an operating condition.

FIG. 7 is a schematic view of the invention in another operating condition.

FIG. 8 is yet another flow chart of the method of the invention.

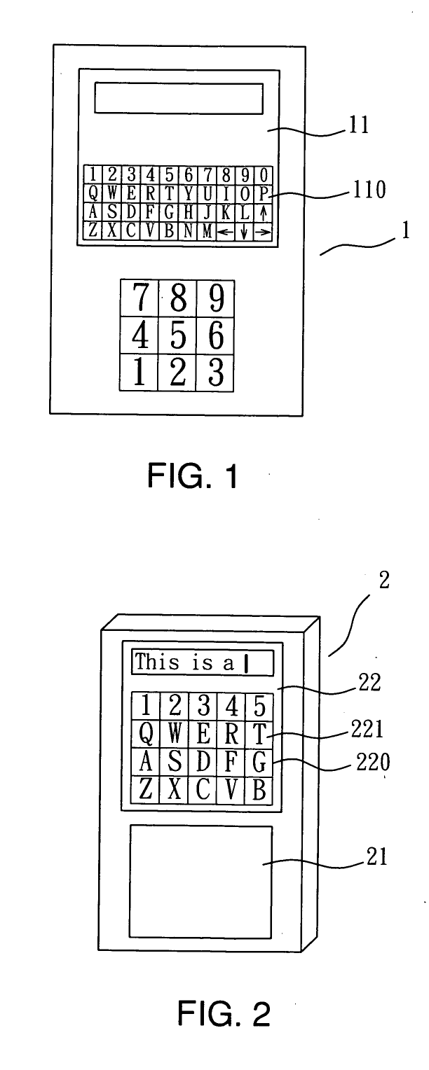

### DESCRIPTION OF THE PREFERRED EMBODIMENTS

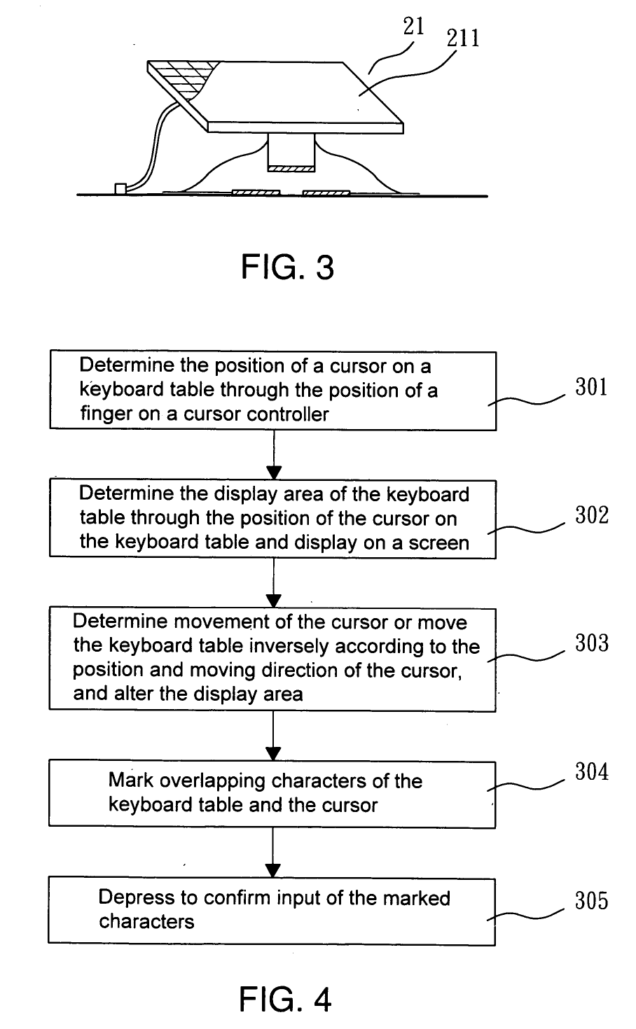

Refer to FIG. 2 for an embodiment of the invention adopted on an electronic device 2. The electronic device 2 includes a cursor controller 21 and a screen 22. The cursor controller 21 (also referring to FIG. 3) has a two-stage touch-sensitive pad 211. The touch-sensitive pad 211 has a two-stage depression control. The first stage may be a resistance induction pad or a capacitance induction pad to sense touching of a finger 5 to generate a displacement signal, and control the position of a cursor 222 on the screen 22 through an absolute coordinate or a relative coordinate (as shown in FIG. 6). The second stage may be a pressure switch (such as pushbutton, piezoelectric ceramic pad or the like) to detect the pressure depressing by the finger 5 to confirm input.

By means of the construction set forth above, the input method with a large keyboard table displaying on a small screen of the invention includes at least the following steps (referring to FIG. 4):

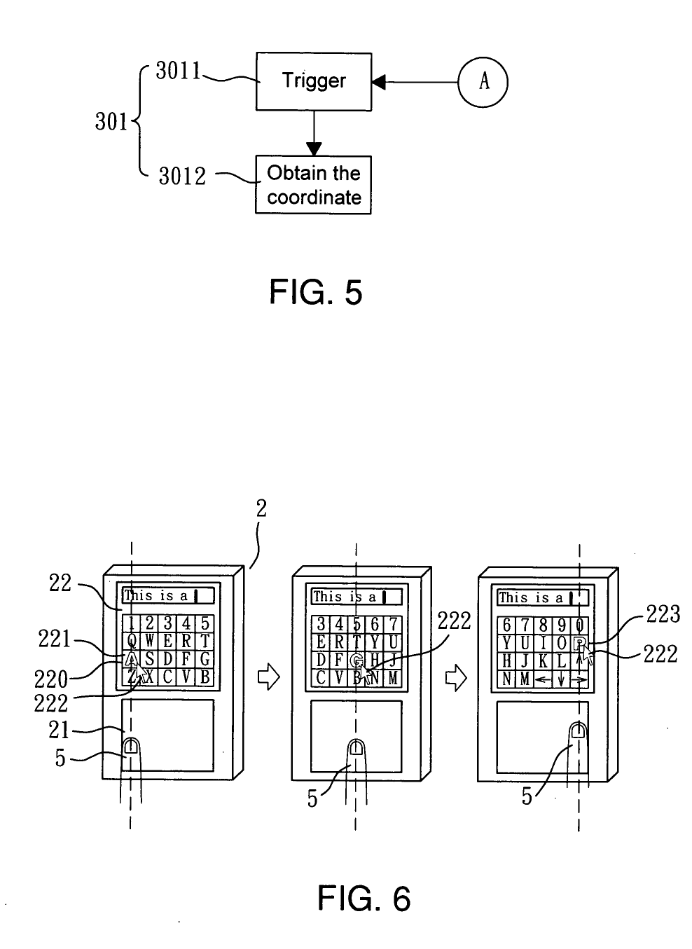

Step 301: The position of the finger on the cursor controller determines the position of the cursor on the keyboard table (also referring to FIG. 5). This step further includes: (1) Triggering: the finger touches the touch-sensitive pad 211 of the cursor controller 21 to trigger a detection action (step 3011); and (2) Obtaining a coordinate: the cursor controller 21 gets the coordinate of the position of the finger 5 through the touch-sensitive pad 211 to allow calculation of a corresponding position on the screen to be done (step 3012);

Step 302: Determine the display area of the keyboard table through the position of the cursor on the keyboard table, and display on the screen: the position of the cursor 222 on the keyboard table 220 on the screen 22 corresponds to the position of the finger 5 touching the cursor controller 21, and the display area of the keyboard table 220 also is determined at the same time. As shown in FIG. 6, when the touching position of the finger 5 on the cursor controller 21 is different, the cursor 222 on the screen 22 responds accordingly, and a different area is displayed on the keyboard table 220;

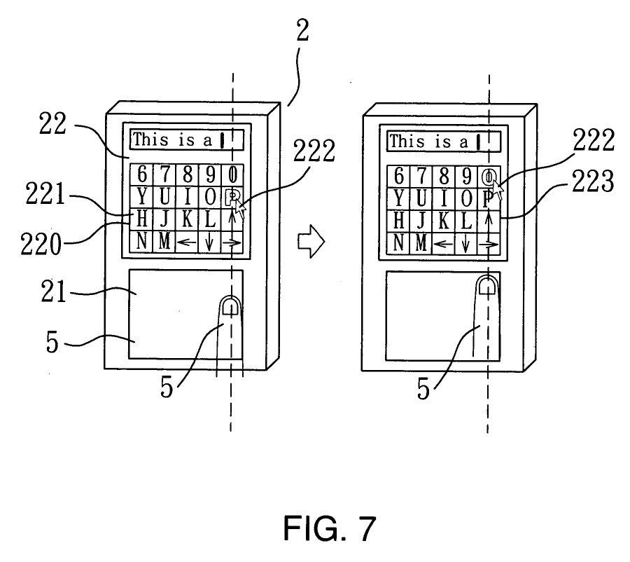

Step 303: Alter the display position of cursor moving or move the keyboard table inversely according to the position and moving direction of the cursor: the touching position of the finger 5 on the cursor controller 21 is corresponding to the cursor 222 on the keyboard table 220 on the screen 22, and the corresponding position on the keyboard table 220 is displayed. Namely the display position of cursor movement or inverse movement of the keyboard table 220 is determined by the position and moving direction of the cursor 222. For instance in FIG. 6, when the finger 5 is moved from left to right, the keyboard table 220 is moved inversely correspondingly until the right border 223 of the keyboard table 220 and the cursor 222 appear at the same time, then the movement of the keyboard table 220 stops, and movement occurs on the cursor 222 to enable users to select desired characters (referring to FIG. 7);

Step 304: Mark overlapping characters on the keyboard table and the cursor: mark a character 221 pointing by the position of the cursor 222, and display the character 221 to differentiate it from other characters of the keyboard table 220; and

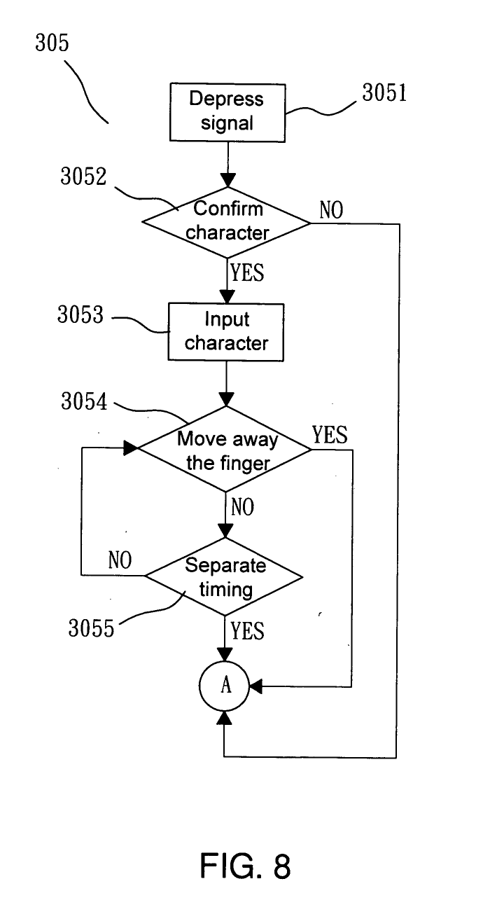

Step 305: Depress the marked character to confirm input (referring to FIG. 8). This step, further includes: (1) depress signal (step 3051): a depression signal of the finger 5 is obtained by the cursor controller 21 through the touch-sensitive pad 211; (2) confirm character (step 3052): the cursor controller 21, through the touch-sensitive pad 211, detects the pressure of the depression of the finger 5; if a depression is detected, executes step 3053; otherwise go back to step 301; (3) input character (step 3053): input the marked character into the electronic device 2; (4) move away the finger (Step 3054): The touch-sensitive pad 211 detects whether touching of the finger exists; if positive, execute Step 301; otherwise execute Step 3055; (5) time separation (step 3055): If the touch-sensitive pad 211 doesn't detect that touching of the finger exceeds a preset time period, the keyboard table 220 disappears from the screen 22, and return to Step 301; otherwise execute Step 3054.

In short, the input method of the invention can improve operation convenience by displaying a large keyboard table on a small screen to facilitate fast data entry.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. An input method with a large keyboard table displaying on a small screen, comprising the steps of;
determining the position of a cursor on a keyboard table through the position of a finger on a cursor controller;
determining a display area of the keyboard table through the position of the cursor on the keyboard table and displaying on a screen;
determining movement of the cursor or moving the keyboard table inverse according to the position and moving direction of the cursor and altering the display area;
marking overlapping characters of the keyboard table and the cursor; and
depressing to confirm input of the marked characters.

2. The input method of claim 1, wherein the cursor controller is a two-stage depression touch-sensitive pad that includes a first stage finger depression to control movement of the finger and a second stage depression to confirm input of a character where the cursor is located or a selected function key.

3. The input method of claim 1, wherein the touch-sensitive pad of the cursor controller controls the cursor on the screen through an absolute coordinate.

4. The input method of claim 1, wherein the screen is smaller than eight inches.

5. The input method of claim 1, wherein the height or the width of the screen is smaller than the height or the width of the complete keyboard table being displayed.

6. The input method of claim 1, wherein the cursor is controlled by the cursor controller and marked by a cursor label on the screen.

7. The input method of claim 1, wherein the cursor is a marked character or function key selected by the cursor controller.

8. The input method of claim 1, wherein the keyboard table is a table or a graphic consisting of a plurality of characters or function keys.

9. The input method of claim 1, wherein the keyboard table is larger than a display area of the screen to be displayed at the same time (in terms of height and width), the screen displaying only a portion of the keyboard table.

10. The input method of claim 1, wherein the keyboard table appears automatically on a display area of the screen when the cursor controller is operated by a user, the keyboard table automatically disappears from the display area of the screen after the cursor controller is not being operated by the user for a selected time period.

11. The input method of claim 1, wherein the step of determining movement of the cursor or moving the keyboard table inverse according to the position and moving direction of the cursor means that the keyboard table is moved inversely on the screen until the display area of the keyboard table displays the cursor and one border of the keyboard table concurrently, then the movement of the keyboard table stops to substitute the movement of the cursor.

12. The input method of claim 1, wherein the step of determining movement of the cursor or moving the keyboard table inverse to alter the display area according to the position and moving direction of the cursor means that the cursor remains still on a selected position on the display area, and the keyboard table is moved inversely on the screen.
